(19) United States
(12) Patent Application Publication
(10) Pub. No.: US 2018/0064069 A1
(43) Pub. Date: Mar. 8, 2018

(54) Apparatus for locking in position at least one living bird for recording characteristic vibrational spectra and for sexing

(71) Applicant: AGRI Advanced Technologies GmbH, Visbek (DE)

(72) Inventors: Sven Meissner, Branderbisdorf (DE); Björn Fischer, Limbach-ch-Oberfohna (DE)

(21) Appl. No.: 15/559,157

(22) PCT Filed: Mar. 18, 2016
(86) PCT No.: PCT/EP2016/055994

§ 371 Date: Sep. 18, 2017

(30) Foreign Application Priority Data
Mar. 18, 2015 (EP) 15159686.3

(51) Int. Cl. A01K 45/00; A01K 37/00; G01N 21/65

(52) U.S. Cl. CPC A01K 45/00; G01N 21/65; A01K 37/00

(57) ABSTRACT

The present invention relates to an apparatus for locking at least one body part of a living bird in position for recording characteristic vibrational spectra, wherein the apparatus comprises a relief mask for inserting the body part to be locked in position, at least one movable supporting arm provided for locking the body part in position, and a sensor access with a light channel for directing the stimulation light irradiated by a light source onto the locked body part and for collecting the light back-scattered by the locked body part. The present invention further relates to devices and methods for determining the sex of living birds.

The present invention relates to an apparatus for locking in position at least one body part of a living bird, said apparatus allowing for recording characteristic vibrational spectra by means of which the sex of the living bird can be determined noninvasively, in particular by means of Raman spectroscopy. The present invention further relates to a device and a method for recording characteristic vibrational spectra for determining the sex of one or more living birds.

The present invention serves for determining the sex of living birds with the help of vibrational spectroscopic methods, preferably directly at the living bird, e.g., in body regions that are well supplied with blood and have a high DNA content, in particular at the beak and/or foot.

Due to strong specializing in the field of chicken breeding, known as hybridization, the sexing of newly hatched chicks, in particular day-old chicks, is of extraordinary importance. In laying hen production, the sexing usually takes place manually and/or visually by means of cloaca morphology, the color of the feathers, or the shape of the feathers of certain feather regions.

The male chicks of the laying hen line are required for breeding only in small number and/or are not suitable for grow-out due to their genetics and are therefore sorted out as byproducts and killed immediately after hatching.

The currently established method of manual presentation of the cloaca can entail injuries which may cause loss of the chick or at least a reduced vitality of the chick. Furthermore, cross-contamination from one bird to another cannot be excluded. In addition, said method is stressful for the birds and is comparatively cost-intensive.

Manual sexing with the help of cloaca morphology applied by the inspector requires mechanical presentation of the cloaca, wherein the otherwise covered sexual characteristics are turned to the outside by means of pressure. Injuries caused to the newly hatched chicks and/or cross-contamination of germs, as has already been outlined above, cannot be excluded. Moreover, when paying attention to handling the chicks as gently as possible, the accuracy directly depends on the individual skill of the inspector and is not stable.

An apparatus and a method for treating the lower beak of a bird for morphologically modifying the beak properties, preferably for beak treatment with tongue protection, are described in U.S. Pat. No. 7,363,881 B2 and WO 2005/046323 A, wherein the apparatus comprises a bird head positioning device, a non-contact energy source emitting energy, and an energy director. The apparatus further comprises a tongue control protrusion proximate the bird head positioning device, wherein the tongue control protrusion presses into the throat of the bird proximate the lower beak when the lower beak of the bird head protrudes through the beak receiving aperture. The bird head positioning device comprises first and second major sides and a beak receiving aperture formed though the first and second major sides, wherein the bird head positioning device is suitable for positioning a bird head proximate the first major side, wherein at least a portion of the lower beak of the bird head protrudes through the beak receiving aperture and is exposed proximate the second major side of the bird head positioning device. The energy director directs energy from the non-contact energy source, wherein energy emitted from the non-contact energy source is incident on at least a portion of the lower beak exposed proximate the second major side of the bird head positioning device. By means of the energy emitted, at least a portion of the biological tissue of the lower beak is killed or atrophied, which immediately or subsequently leads to a morphological modification of the beak properties.

US 2004/0143278 A1 relates to an apparatus for receiving the head of a living bird and having a device for non-contact heating of the beak of the bird. Poultry carriers and methods of restraining poultry are known from EP 2 381 885 B1.

A method for sexing birds is described in DE 10 2007 013 107 A1, where DNA relevant cell material of the bird to be sexed is investigated with the help of light and the molecular vibrations are measured, wherein the spectrum of molecular vibrations resulting from the light is recorded and compared with predetermined and gender-related DNA structures of reference spectra representing the bird species to be investigated, and wherein the respective sex is assigned to the bird on the basis of the DNA content of the cell material by means of this spectral comparison. The DNA relevant cell material can be taken from the shaft of a young feather of the bird. A problem accompanying this process is that obtaining DNA relevant cell material from the shaft of a feather of a young bird is quite time-consuming due to several preparatory and preliminary steps that are involved.

An automated poultry conveying system according to U.S. Pat. No. 7,367,284 B2 comprises a sexing station which is not described in greater detail.

An object of the present invention is, inter alia, to provide an apparatus for locking at least one body part of a living bird in position for recording characteristic vibrational spectra, said apparatus being configured such that characteristic molecular vibrations can easily and safely be measured from outside and non-invasively at a preferred position of a body part of the bird. The present invention also aims at providing a device and a method for sexing birds quickly, safely and gently.

These objects are solved by the features of the claims.

According to one aspect of the present invention, an apparatus for locking at least one body part of a living bird in position for recording characteristic vibrational spectra is provided, wherein the apparatus comprises a relief mask for inserting the body part to be locked, at least one movable supporting arm provided for locking the body part, and a sensor access with a light channel for directing the stimulation light irradiated by a light source onto the locked body part and for returning the light back-scattered by the locked body part.

The relief mask may comprise at least one recess which essentially corresponds to the shape of the body part to be locked. The sensor access preferably runs through the relief mask.

The body part preferably comprises a head, a beak and/or a neck of a bird, and the relief mask preferably comprises a recess for the head, a recess for the beak, and/or a recess for the neck of the bird, wherein the recesses preferably form a uniform space in the shape of the relief mask. The relief mask is preferably formed such that at least a front part of the bird head can be received.

The at least one movable supporting arm can be arranged in the region of the recess for the neck of the bird.

The apparatus preferably comprises a first light trapping that is preferably arranged between the sensor access and the recess for the head in order to protect the head and in particular the eyes of the bird from the stimulation light.

The apparatus may further comprise a head supporting member, a beak encasing member, and/or a neck supporting member, wherein the head supporting member matches the recess for the head, the beak encasing member is associated with the recess for the beak, and the neck supporting member is associated with the recess for the neck. The supporting and encasing members may be combined to form one or more material blocks through which the closed light channel may run.

The light channel may run through the head supporting member and/or the beak encasing member to a measurement area (40) which is preferably located at the beak of the bird since the stimulation of characteristic vibrational spectra can optionally take place there. The light channel may be directed to approximately a centered region of an upper bulge of the recess for the beak. The neck supporting member is preferably integral with the beak encasing member.

Preferably, the head supporting member may comprise a head receiving aperture and the beak encasing member may comprise a beak receiving aperture, both of which are parts of the relief mask.

The apparatus may further comprise a first scavenging air inlet, wherein the scavenging air inlet preferably runs through the light trapping and the head supporting member and opens out into the light channel and serves for cleaning said light channel.

A second light trapping may further be arranged at the beak encasing member and/or the neck supporting member in order to protect the bird, wherein preferably a second scavenging air inlet runs through the second light trapping, said second scavenging air inlet opening into the light channel.

Preferably, a focusing assembly is arranged within the light channel, e.g., in the form of an objective or a common converging lens. The light channel and/or the sensor access may comprise access to the focusing assembly in order to allow for manual adjustment of the focusing assembly. The focusing assembly may also be controlled automatically.

The at least one movable supporting arm may be formed as at least one movable locking lever, as a pivotable bow-shaped supporting arm adapted to the body part, and/or may be club-shaped, wherein the movement of the supporting arm is preferably released and reset in a controlled manner. The at least one movable supporting arm is preferably formed for linear displacement or provided pivotally.

The at least one movable supporting arms may be arranged in pairs; preferably, two supporting arms are provided, for example, in the region of the recess for the neck.

The apparatus may further comprise at least one loudspeaker for acoustic degression of the bird's activity, wherein the loudspeaker preferably communicates with the at least one supporting arm or is mounted thereto.

The beak encasing member may additionally comprise at least two recesses for the nostrils of the bird.

According to another aspect of the present invention, the apparatus further comprises a unit for recording characteristic vibrational spectra, with a light source, a sensor, and an analysis unit. The light source may produce the stimulation light, the sensor may collect the back-scattered light, and the analysis unit may analyze the characteristic vibrational spectra. By virtue of such analysis, living birds may be sexed. The present invention also relates to such a unit without the abovementioned locking apparatus, or such a unit in combination with an arbitrary apparatus for locking a living bird. The analysis unit is preferably a Raman spectroscopy unit.

According to another aspect of the present invention, a device for determining the sex of a plurality of living birds on the basis of characteristic vibrational spectra is provided, the device comprising a rondel or circular arrangement or an endless belt and at least two apparatuses coupled thereto for locking the living birds in position, in particular a plurality of apparatuses as described above. Preferably, the device further comprises at least one unit for recording characteristic vibrational spectra. Preferably, a Raman spectroscopy apparatus with a light source, a sensor, and an analysis unit is used therefor.

The at least two locking apparatuses are preferably mounted on an outer edge of the rondel or circular arrangement or the endless belt, and the device may further comprise a central unit for supplying energy to the at least two apparatuses for locking the living birds, a unit for supplying scavenging air to the locking apparatuses, wherein the unit for supplying scavenging air preferably surrounds the energy supply unit, and at least one separation unit.

The separation unit may further communicate with a sex determination analysis unit and comprise preferably at least a first conveyor belt and at least a second conveyor belt.

The device may comprise a predetermined first halt position for receiving the birds to be locked and for recording the measured data, and a predetermined second halt position for separating the already sexed birds by means of the separation unit.

According to another aspect of the present invention, a method for determining the sex of living birds is provided, in particular using an apparatus as described above or one of the aforementioned devices, wherein the method comprises the following steps: locking a body part of the living bird in position; irradiating stimulation light onto the locked body part using a light channel; guiding light back-scattered by the body part locked in position back through the light channel; recording and/or analyzing a characteristic vibrational spectrum of the back-scattered light. The method may further comprise the determination of the sex by way of analyzing the characteristic vibrational spectrum using at least one chemometric method.

The present invention serves for determining the sex of birds with the help of vibrational spectroscopic methods, preferably non-invasively directly at the living bird, e.g., in body regions that are well supplied with blood and have a revealed, high DNA content, in particular at the beak and/or foot.

In the following, the present invention is explained in more detail by means of exemplary embodiments and the Figures.

The Figures show:

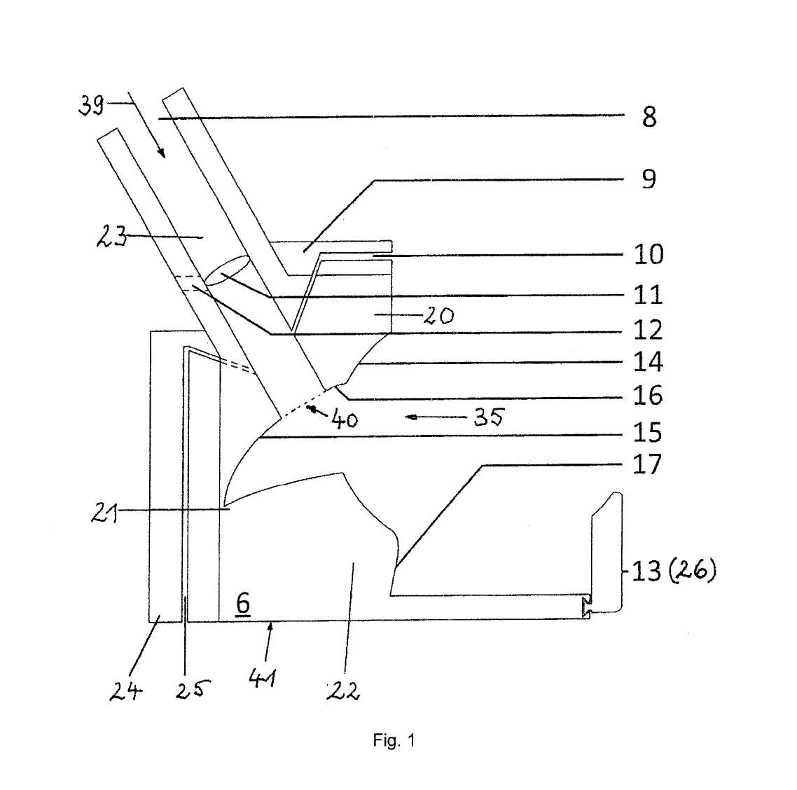

FIG. 1 a schematic illustration of a side view of an apparatus according to an embodiment of the present invention,

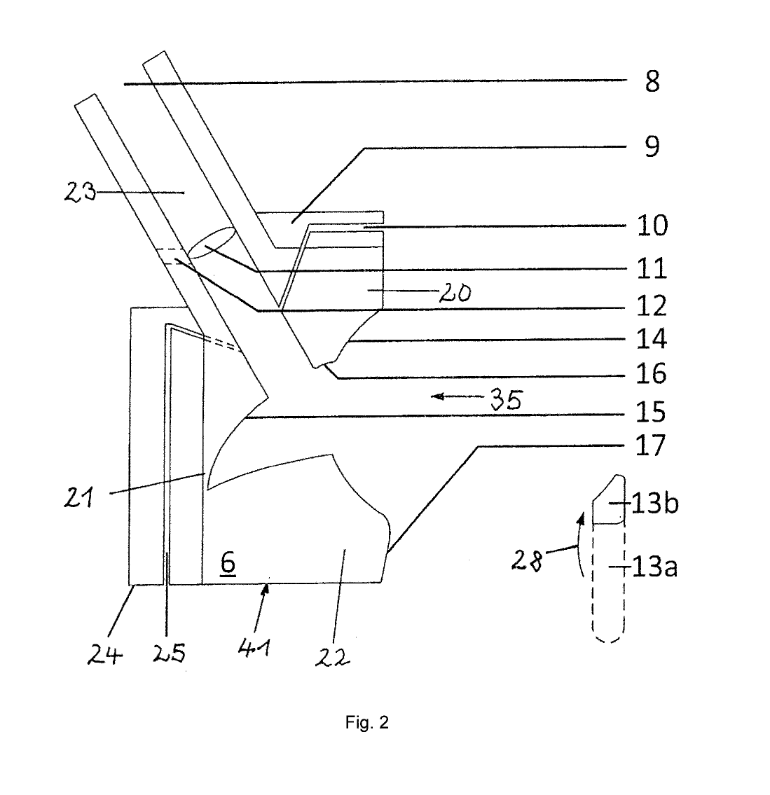

FIG. 2 a schematic illustration of a side view of an apparatus according to another embodiment of the present invention,

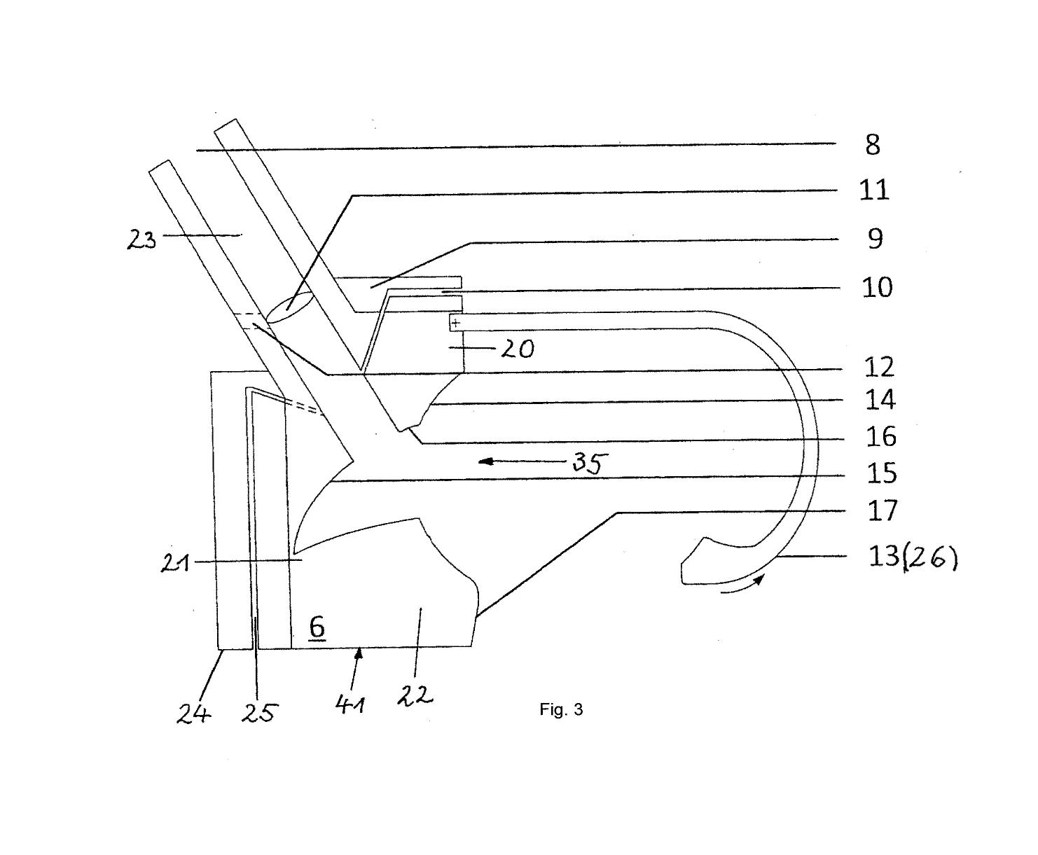

FIG. 3 a schematic illustration of a side view of an apparatus according to another embodiment of the present invention,

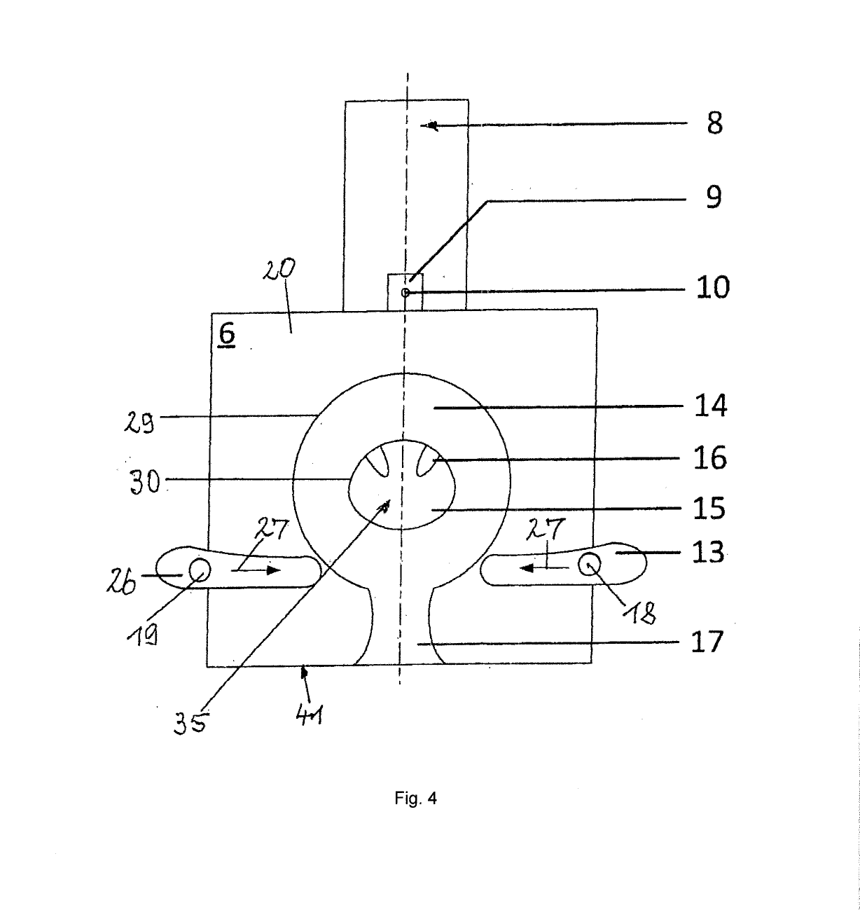

FIG. 4 a schematic illustration of a rear view of an apparatus according to an embodiment of the present invention,

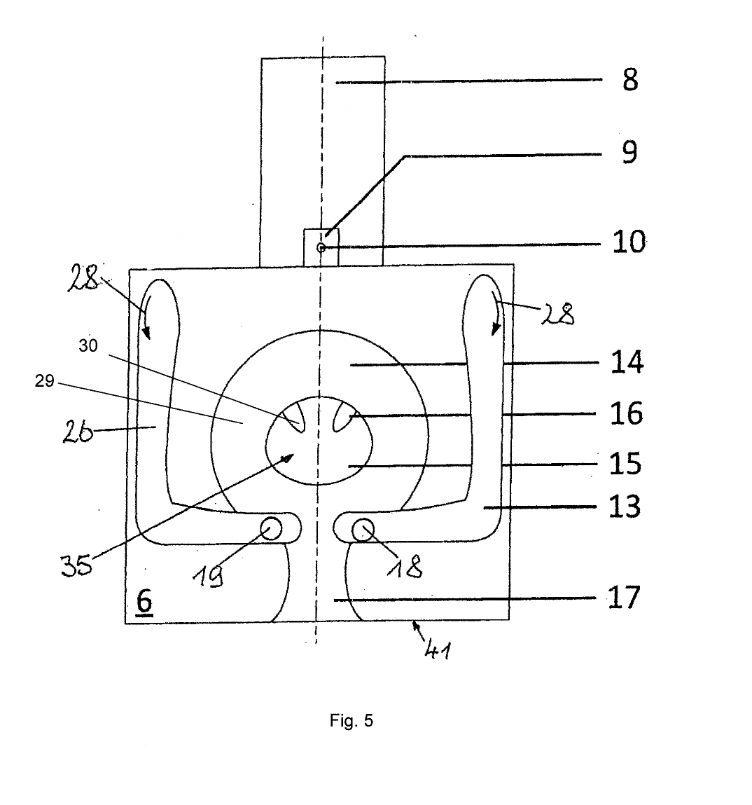

FIG. 5 a schematic illustration of a rear view of an apparatus according to an embodiment of the present invention,

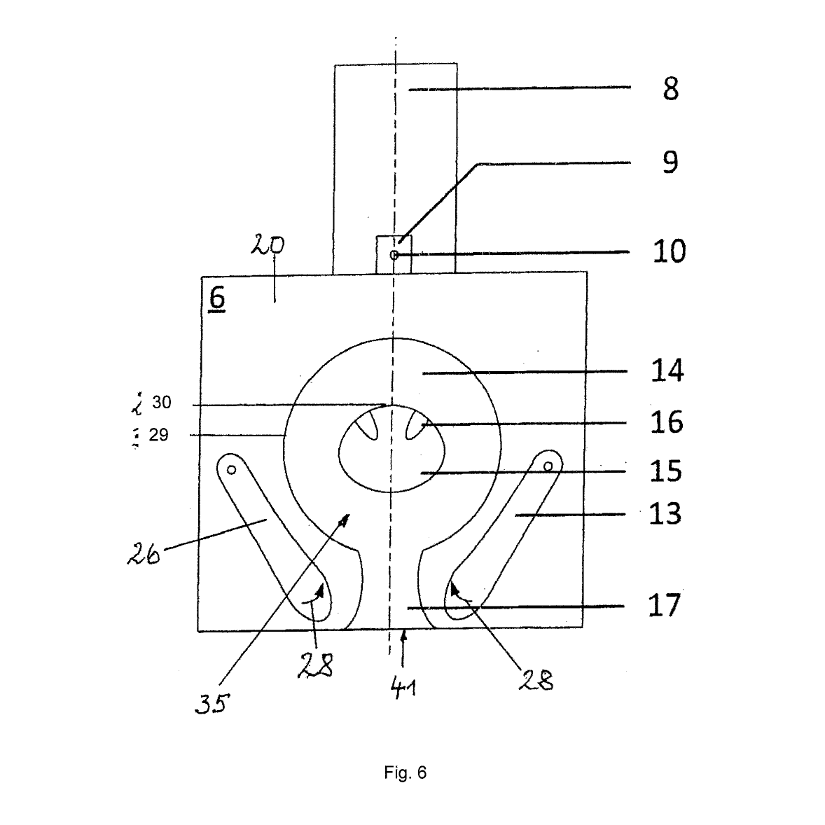

FIG. 6 a schematic illustration of a rear view of an apparatus according to another embodiment of the present invention,

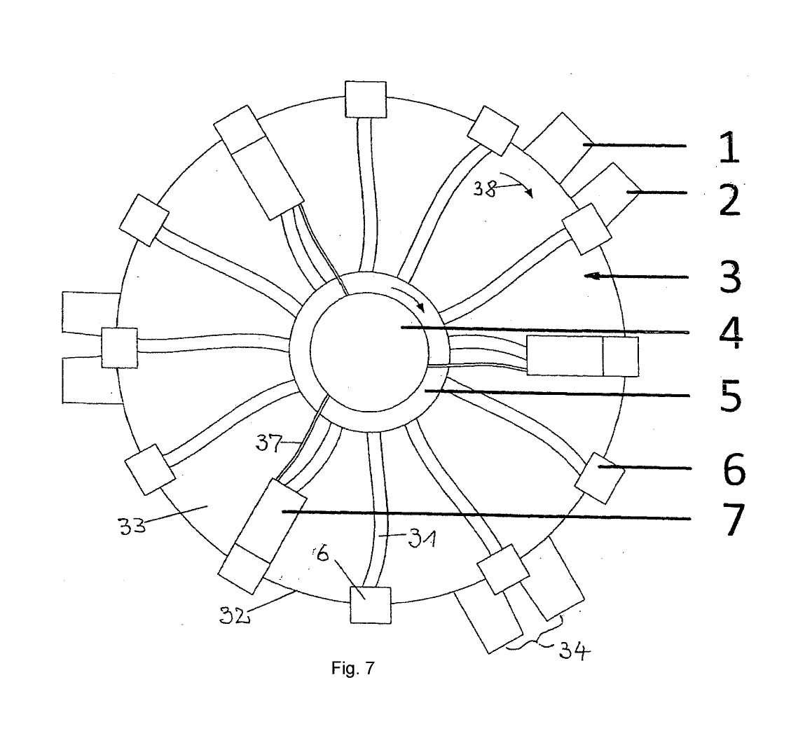

FIG. 7 a schematic illustration in top view of a device according to an embodiment of the present invention with a plurality of apparatuses according to any one of FIGS. 1 to 6,

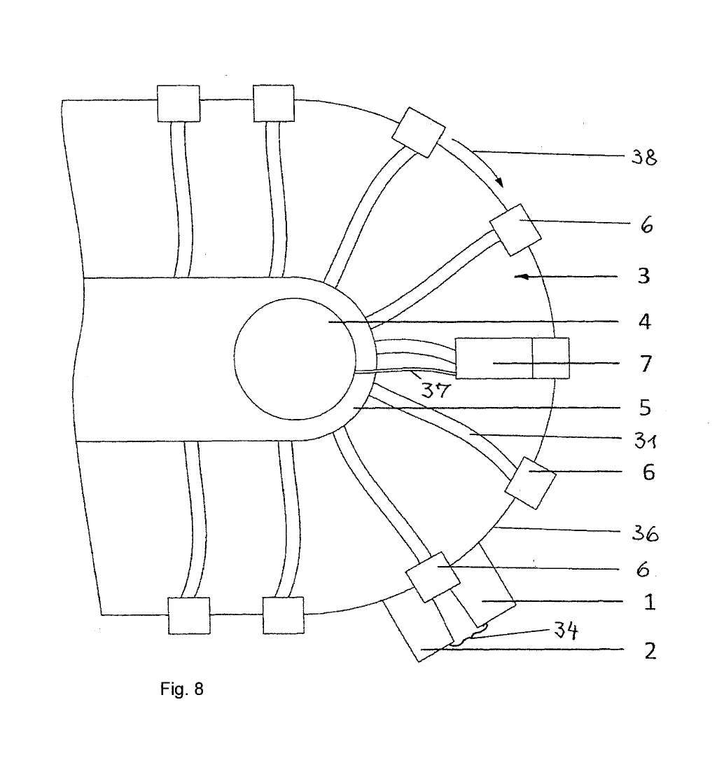

FIG. 8 a schematic illustration in top view of a device according to another embodiment of the present invention with a plurality of apparatuses according to any one of FIGS. 1 to 6,

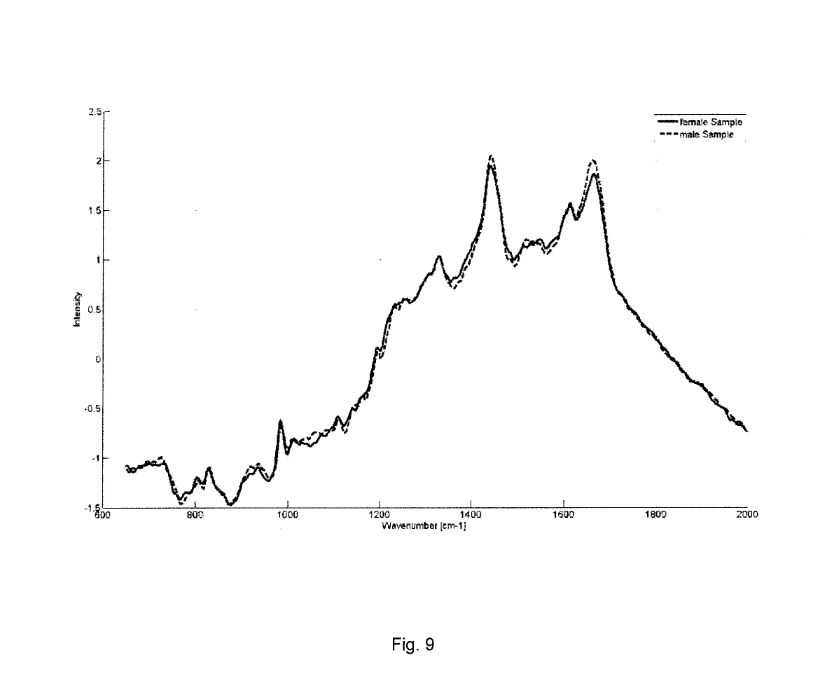

FIG. 9 a schematic illustration of two measurement signals according to the present invention,

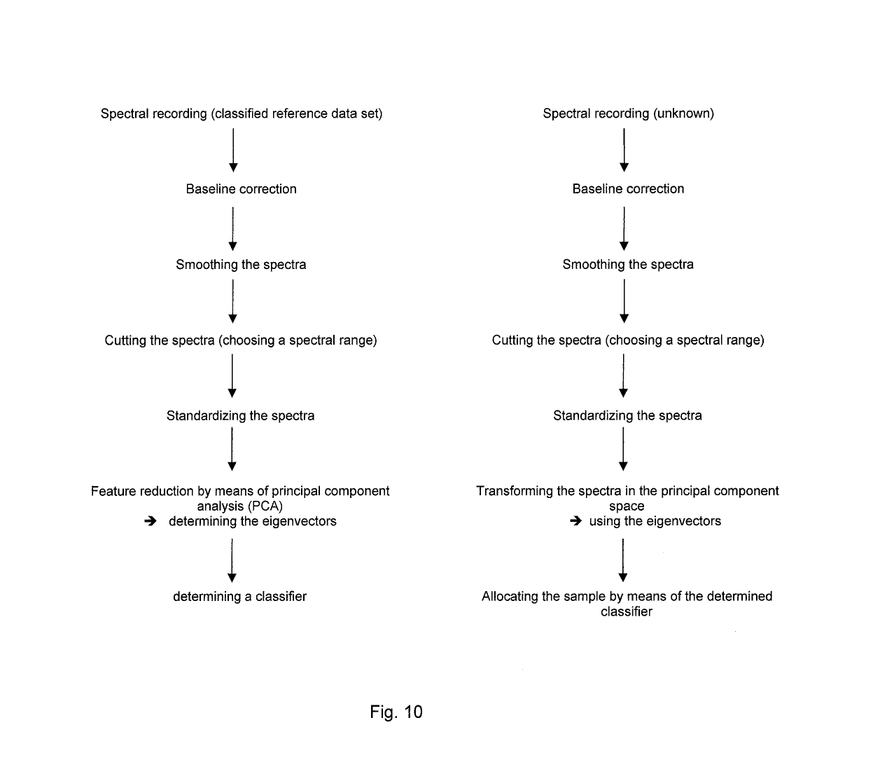

FIG. 10 an exemplary assembly plan for determining the sex of a living bird using chemometric methods according to an embodiment of the present invention, and

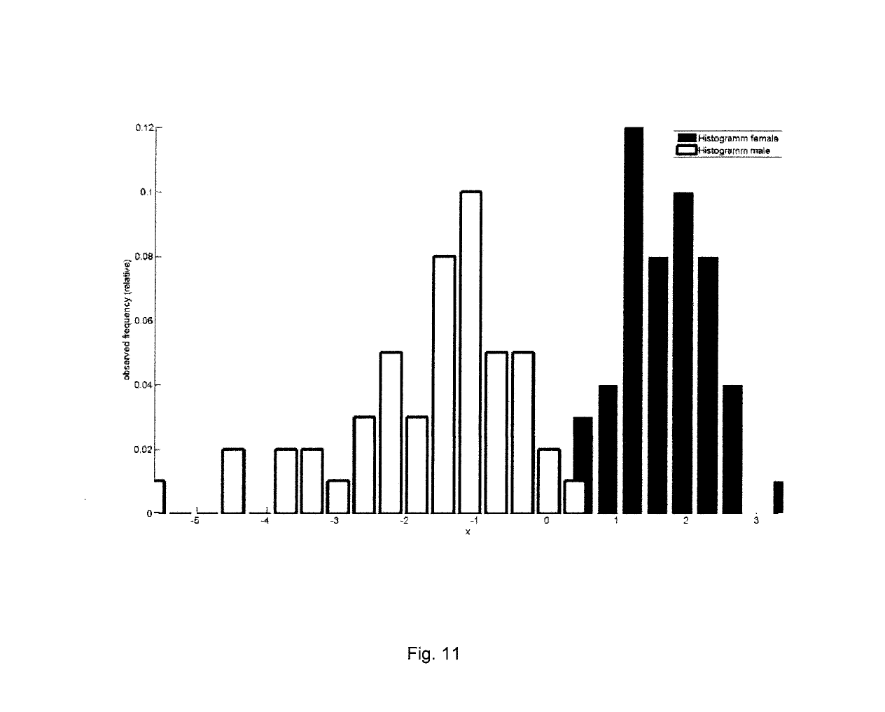

FIG. 11 an exemplary histogram of the calculated classifiers according to FIG. 10 according to an embodiment of the present invention.

FIG. 1 shows a schematic illustration of an apparatus 6 for locking at least one body part of a living bird in position for recording characteristic vibrational spectra. The apparatus is particularly suitable for recording characteristic vibrational spectra of light back-scattered by the body part for Raman spectroscopy for determining the sex of the bird. The apparatus 6 comprises at least one material block 41 having a sensor access 8 with a light channel 23 for directing the stimulation light 39 irradiated by a light source (not shown) to a measurement area 40 and for returning the back-scattered light from which characteristic molecular vibrations can be extracted from the predetermined measurement area. A relief mask 35 for inserting the body part to be locked is associated with the measurement area 40. Further, at least one movable supporting arm 13, 26 provided for locking the body part in position is provided in a predetermined distance to the relief mask 35.

The relief mask 35 comprises at least one recess 14, 15, 16 and/or 17 in depth which largely corresponds to the shape of the at least one body part to be locked, e.g., the head.

The material block 41 preferably consists of solid material.

In the following, the apparatus 6 is exemplarily described for relief masks in consideration of the beak, head, and neck as body parts. The invention, however, also comprises relief masks for receiving other body parts, e.g., a foot or both feet of the bird.

The locking apparatus 6 in the schematic illustration of FIG. 1 shows a plurality of body parts of a bird determinable by means of Raman spectroscopy, wherein the body parts include a head, a beak, and a neck of a bird. The apparatus 6 comprises the sensor access 8 for directing the stimulation light irradiated by a light source (not shown) as well as means for recording at least the molecular vibrations stimulated thereby, a recess 14 for the head of a bird, a recess 15 for the beak of a bird, a recess 17 for the neck of a bird, and a light trapping 9 located between the sensor access 8 and the recess 14.

The recesses 14, 15, and 17 form a uniform space in the shape of a relief mask 35 at least for the front part of the head of a bird. In the area of the recess 17 for the neck and/or in the area of the beak receiving aperture 29, supporting arms 13, 26 are movably arranged for locking the bird head.

The apparatus 6 further comprises: a head supporting member 20, a beak encasing member 21, and a neck supporting member 22 which are associated with the following recesses in form of a relief mask 35 for receiving at least the front part of the bird head: the head supporting member 20 matches the recess 14 for the head of the bird, the beak encasing member 21 matches the recess 15 for the beak, the neck supporting member 22 matches the recess 17 for the neck or further body parts of the bird. In the sensor access 8, the closed light channel 23 is located, which communicates with the head supporting member 20 and the beak encasing member 21 and which optionally runs therethrough. The neck supporting member 22 may be integral with the beak encasing member 21. A recess 14 for the head of the bird is allocated on the bottom side of the head supporting member 20, and a light trapping 9 is allocated at least on the upper side thereof. The recess 15 for the beak is located in the beak encasing member 21. There is also the option of advancing the sensor access 8 with the light channel 23 to the beak from the bottom side of the beak and to utilize the bottom side of the beak for recording the measured data and for analyzing said data using, e.g., the method of Raman spectroscopy. Here, the closed light channel may run through the neck supporting member 22 and/or the beak encasing member 21.

The light channel 23 shown in FIG. 1 is directed approximately centrally onto the recess 15 for the beak from above. Preferably, the light channel 23 terminates in the recess 15 for the beak such that the light may hit the front part region between the egg tooth, the tip of the beak, and the skin of the beak on the upper side of the beak, and may be back-scattered therefrom into the light channel 23.

A first scavenging air inlet 10 runs through the light trapping 9 that protects the eyes of the bird and the head supporting member 20, said first scavenging air inlet 10 opening into the light channel 23 for cleaning said light channel and optionally being supplied with compressed air from a compressed air source (not shown).

In FIG. 1, a second light trapping 24 opening into the light channel 23 is preferably located at the beak encasing member 21, wherein a second scavenging air inlet 25 may run through the second light trapping 24 for improved cleaning of the light channel 23 which may also be supplied with compressed air, e.g., from the same source.

In FIG. 1, a focusing assembly 11 provided for incident and scattered light is also shown within the light channel 23, e.g., in the form of an objective or a common lens.

The supporting arms 13 and 26 (covered behind supporting arm 13) adapted to the body part to be held, e.g., the back of the head, are arranged in a pivotable manner at the apparatus 6 at the neck supporting member 22, in particular in an adjustable distance from the relief mask 35. The locking apparatus comprises at least one mount for fixing the head, wherein at least one lever arm either holds the back of the head in position centrally, e.g., spoon-like or fork-like, or functions as a support in the neck region and is laterally connected to the apparatus. The Figures show a supporting arm 13, a fixing part 13b, and a swiveling adjustable supporting arm 13a. The contour and/or shape of the adjustable supporting arms 13a is adapted to the individual anatomy of the bird species to be investigated.

In FIG. 1, it is schematically illustrated that the light channel 23 comprises an access 12 in the sensor access 8 for carrying out the focusing of the object.

FIG. 2 shows a schematic illustration of a side view of the apparatus 6 according to the present invention for locking the heads of birds in position with two scavenging air inlets 10 and 24, the relief mask 35 as well as two separately arranged and adjustable supporting arms 13, 26 (covered). The supporting arms 13 and 26 may be formed as two parts, a part 13a as the adjustable holding member of the supporting arm at the body part, and a part 13b as the fixing part of the supporting arm at the apparatus or at an external fixing device.

FIG. 3 shows a schematic illustration of a side view of the apparatus according to the invention for locking the heads of birds in position with scavenging air inlets 10 and 24, the relief mask 35, and bow-like supporting arms 13 and 26, wherein the bow-like supporting arms 13 and 26 (covered) may also be associated with the apparatus 6 directly or separately via another fixing device (not illustrated).

FIG. 4 shows a schematic illustration of a rear view and top view, respectively, of the relief mask 35 of the apparatus 6 according to the present invention for locking the head of a bird in position with a head receiving aperture 29 and a beak receiving aperture 30 as well as linearly displaceable supporting arms 13 and 26. In this arrangement, at least two movable locking levers 13 and 26 as supporting arms for the head of the bird are arranged in the area of the neck supporting member 22, wherein the movement of the locking levers 13, 26 shown as arrows 27 may be activated and returned back subject to the recorded measured data.

The movable locking levers 13, 26 may be formed in linear displacement (arrows 27) or, as shown in FIG. 5 and FIG. 6, be provided with a rotational and/or pivoting implementation (arrows 28), preferably in the direction to the neck region of the bird.

The supporting arms 13, 26 are generally arranged in pairs on the right and left in the area of the neck supporting member 22 and in a predetermined spacing.

The locking levers 13, 26 may communicate with and/or incorporate the loudspeakers 18, 19 as acoustic units. The loudspeakers as first and second acoustic unit may also be arranged at a different position in the region of the ears of the bird.

FIG. 5 is a schematic illustration of a rear view of the apparatus 6 according to the present invention for locking the head of a bird in position with a head receiving aperture 29 and a beak receiving aperture 30 as well as two pivotally mounted supporting arms 13 and 26 which visibly face each other in L-shape and in reversed L-shape in the rear view.

FIG. 6 shows a schematic illustration of a rear view of the apparatus 6 according to the present invention for locking the head of birds in position with a head receiving aperture 29 and a beak receiving aperture 30 as well as club-shaped supporting arms 13 and 26 being mounted pivotally and pairwise. The two supporting arms 13 and 26 move in the direction 28. Just as in FIGS. 4 and 5, at least two recesses 16 for nostrils are incorporated into the beak encasing member 21. The head supporting member 20 has the head receiving aperture 29 and the beak encasing member 21 has the beak receiving aperture 30.

FIG. 7 shows a schematic illustration in top view of a device for determining the sex of living birds in the form of a carousel and containing a plurality of apparatuses 6 according to the present invention. The carousel 3 according to FIG. 7 for use with a plurality of apparatuses 6 comprises a circular arrangement or rondel 33, a central unit 4 for recording the measured data and for supplying the apparatuses 6 with energy, a unit 5 for supplying scavenging air by means of a compressed-air piping 31 to the scavenging air inlets 10 of the apparatuses 6, wherein the unit 5 surrounds the unit 4, and at least one preferably stationary Raman spectroscopy base unit 7, the components of which are being fed by the energy supply. The apparatuses 6 are mounted at the edge 32 of the rondel 33. The device comprises at least one predetermined first halt position for receiving the birds and for actually recording the measured data, and optionally at least a predetermined second halt position for separating the chicks whose sex has already been determined. Further, at least one separating unit 34 with a first conveyor belt 1 for the main product, e.g., female chicks, and with a second conveyor belt 2 for the byproduct, e.g., male chicks, is provided. The separation unit 34 communicates with a sex determination analysis unit (not illustrated).

The moving direction 38 shows the running direction of the rondel 33.

FIG. 8 shows a schematic illustration in top view of another device 3 for determining the sex of living birds using various apparatuses 6. The device 3 according to FIG. 8 comprises an endless belt 36, a unit 4 for recording the measured data and supplying the apparatuses 6 with energy, a unit 5 for supplying scavenging air to the scavenging air inlets 10 and 25 of the apparatuses 6 by means of a compressed-air piping 31, wherein the unit 5 surrounds the unit 4, and at least one stationary Raman spectroscopy base unit 7, the components of which are being fed by the energy supply via supply lines 37. The apparatuses 6 are attached to the endless belt 36. The device comprises at least one predetermined first halt position for receiving the birds and for actually recording the measured data, and optionally at least one predetermined second halt position for separating the chicks whose sex has already been determined. Further, at least one separation unit 34 with a first conveyor belt 1 for the main product, e.g., female chicks, and with a second conveyor belt 2 for the byproduct, e.g., male chicks, is provided. The separation unit 34 communicates with a sex determination analysis unit (not illustrated). The sex determination analysis unit may be directly connected with the unit 4 for measurement recording and energy supply.

The Raman spectroscopy base unit 7 may contain sensor units and other associated electric and optical units as well as energy supply lines.

The moving direction 38 shows the running direction of the endless belt 36.

The one or more locking apparatuses 6 may be a part of a device 3 for determining the sex of birds. As described above, for this purpose in the apparatus 6 according to the present invention, the beak of the chick is, e.g., inserted into a beak receiving aperture 30 and positioned such that a vibrational-spectroscopic measurement is made possible in the region between the skin of the beak at least on the upper side of the beak and the egg tooth of the chick. During the few seconds required for recording the measurement data, the beak of the chick is held immovably in the relief mask 35—which may comprise all aforementioned recesses 14, 15, 16, 17—matching the head of the bird, and irradiated with light, e.g., of a laser, of appropriate wavelength and intensity. The characteristic spectrum of the molecular vibrations is measured and compared with representative reference spectra, e.g., in a Raman spectroscopy analysis unit.

For a quick determination of the sex of a large number of chicks, the carousel 3 equipped with appropriate mounts and containing several apparatuses 6 for receiving the chicks, an endless belt, or an appropriate magazine for recording the measured data may be used. The sensor head/sensor access 8 may be flushed with compressed air in the area of the laser optics for decoupling the laser optics from the chick itself and for avoiding impurities. In order to reduce the strain on the chick, the eye region of the chick may be darkened by means of light trappings 9 and 24. In addition, acoustic depression of the chick's activity is possible. For this purpose, a characteristic tone or a tone sequence of appropriate volume is transmitted to the chick by way of in-built loudspeakers 18, 19 and transmitted by either airborne or body-borne sound.

As described, the devices for determining the sex of birds according to invention each comprise a unit for recording and analyzing characteristic molecular vibrations. For example, the vibrational spectroscopic methods mentioned within the scope of DE 10 2007 013 107 B4, in particular the Raman spectroscopy method, may be used for such analysis, wherein the method is adapted to an apparatus that is suitable for the conditions given in the field of hatchery for carefully and automatically conveying, holding, sexing, and removing the bird.

The sexing of the bird locked with the apparatus according to the present invention generally takes place by means of analyzing characteristic vibrational spectra, preferably by means of Raman spectroscopy.

In general, Raman spectroscopy concerns a vibrational spectroscopic method, wherein the sample (e.g., the beak of the chick) is being stimulated to molecular vibration with the help of light of appropriate wavelength.

The scattered light back-scattered from the sample is analyzed. The scattering processes can in general be subdivided into two characteristic scattering processes. On the one hand, the incident light may be scattered elastically (Rayleigh scattering), wherein the incident light and the scattered light have the same frequency. On the other hand, the incident light may be scattered inelastically, wherein the scattered light has a higher or lower frequency than the incident light. Thus, next to the elastically scattered light of the Rayleigh scattering, a frequency-shifted, inelastic scattered radiation, namely Raman scattering, forms on both sides of the excitation line in the scattered spectrum.

A typical Raman spectrum measured according to the invention is shown in FIG. 9 for a wavenumber range of approx. 600 cm⁻¹ to 2,000 cm⁻¹. The continuous measured curve corresponds to a measured curve at a female chick, and the dashed measured curve corresponds to a male chick. The intensity of the scattered radiation differs between the two sexes according to the wavenumber.

Even if the method is described by means of Raman scattering here, other spectroscopic methods may also be deployed as long as these methods allow for a vibrational spectroscopic investigation of the sample (e.g., the beak of the chick). Examples for suitable spectroscopic methods may be IR or THz spectroscopy. The THz radiation or far infrared are rather suitable for investigating weak intramolecular interactions.

Due to the complexity of the spectra, the differences between the sexes are often hard to visualize in the spectrum, therefore chemometric methods for analyzing the spectra are particularly useful. Chemometrics contain the use of statistic and mathematic methods for data analysis. FIG. 10 exemplarily describes an analysis method of the recorded measured data (spectra) for sexing according to the invention. In the present example, the analysis contains recording a classified reference spectrum. For that purpose, a spectrum of a bird of known sex is recorded using the above-described method and a baseline correction is made as a first step. Subsequently, the spectrum is smoothed, e.g., with the help of a moving average, a binomial filter, or polynomial smoothing. Preferably, as a next step the spectrum is cut to a determined range and standardized, e.g., using a mean value, a amount-1-normalization, or with the help of Standard Normal Variant (SNV) Transformation (standardizing to the standard deviation). As a next step, a reduction of variables is carried out with the help of principal component analysis (PCA) (determining the eigenvector). One or more classifiers are then determined from the altered spectrum. Such classifier may be both a minimum-distance classifier and a Bayes classifier or the like. Moreover, the calculation of a discriminant function, i.e., a separation surface, e.g., by means of linear discriminant analysis (calculating one or more discriminant functions including determining the separation force of the principal components) may be advantageous for determining one or more classifiers. As a matter of course, the above-described editing of a spectrum may be repeated several times with different birds of the same sex in order to increase the statistics of the reference data set.

As soon as a reference data set (i.e., a statistically relevant database) is available, the measurement of a bird of unknown sex may be carried out. The steps of editing the measured spectrum are essentially identical to the steps of editing the reference data set. As a last step, the classifiers of the reference data set and the spectrum of the bird of unknown sex are then compared in order to determine the sex.

The reference data set should preferably be generated for male and female birds in order to generate a data set for both cases. However, it is also possible to determine a data set for only one sex in order to find, when measuring a bird of unknown sex, whether or not it matches the reference data set. This would already suffice for determining the sex. Even if here the editing of the spectra is described by means of a workflow, the person skilled in the art may use any known method for editing spectra without deviating from the gist of the present invention.

FIG. 11 shows an exemplary histogram illustrating the distribution for female (black bars) and male (white bars) birds. The histogram was created with the help of the spectra from FIG. 9 using the analysis method according to FIG. 10. More precisely, the spectra were recorded according to the invention with Raman spectroscopy in a wavelength range of 100 cm⁻¹ to 4,278 cm⁻¹. A binomial filter of the 13^{th} order was used for smoothing. Further, the spectral range was cut to 650 cm⁻¹ to 2,000 cm⁻¹, and standardization by means of SNV transformation was carried out. As a further step, a principal component analysis and a discriminant function using 15 principal components were carried out. The histogram shows the distribution of the calculated discriminant values for all observations with respect to female (black bars) and male (white bars) chicks.

While the present invention was described and illustrated in reference to its preferred embodiments, it is obvious to those skilled in the art that different modifications and changes may be made without leaving the scope of protection of the invention. In this way, it is intended that the present invention covers the modifications and changes of this invention provided that they are covered by the scope of protection of the appended claims and their equivalents. In particular, it is clear to those skilled in the art that the features described in connection with a specific preferred embodiment may also be combined with features of other embodiments.

### LIST OF REFERENCE SIGNS

1 conveyor belt
2 conveyor belt
3 device/carousel
4 measured data recording and energy supply
5 scavenging air supply unit
6 locking apparatus
7 Raman spectroscopy base unit
8 sensor access
9 first light trapping
10 first scavenging air inlet
11 focusing/objective for collecting the Raman light
12 focusing access
13 first supporting arm/locking lever
13a adjustable supporting part
13b fixing part
14 head recess
15 beak recess
16 nostrils recess
17 neck/body recess
18 first acoustic unit/first loudspeaker
19 second acoustic unit/second loudspeaker
20 head supporting member
21 beak encasing member
22 neck supporting member
23 light channel
24 second light trapping
25 second scavenging air inlet
26 second supporting arm/locking lever
27 direction of displacement of the supporting arm
28 direction of pivoting movement of the supporting arm
29 head receiving aperture
30 beak receiving aperture
31 compressed-air piping
32 edge of the rondel
33 rondel
34 separation unit
35 relief mask
36 endless belt
37 supply lines
38 moving direction
39 stimulation light
40 measurement area

1. An apparatus for locking in position at least one body part of a living bird for recording characteristic vibrational spectra,
wherein the apparatus comprises:
a relief mask for inserting the body part to be locked in position
at least one movable supporting arm provided for locking the body part in position, and
a sensor access with a light channel for directing stimulation light irradiated onto the locked body part and for returning the light back-scattered by the locked body part.

2. The apparatus according to claim 1,
wherein the relief mask comprises at least one recess which essentially corresponds to the shape of the body part, and wherein the sensor access runs through the relief mask.

3. The apparatus according to claim 1,
wherein the body part comprises a head, a beak, and/or a neck of a bird, and wherein the relief mask comprises a recess for the head, a recess for the beak, and/or a recess for the neck of the bird, wherein the recesses form a uniform space in the shape of the relief mask.

4. The apparatus according to claim 3,
wherein the at least one movable supporting arm is arranged in the region of the recess for the neck of the bird.

5. The apparatus according to claim 1,
wherein the apparatus further comprises a first light trapping that is arranged between the sensor access and the recess for the head.

6. The apparatus according to claim 3,
wherein the apparatus further comprises:
a head supporting member,
a beak encasing member, and/or
a neck supporting member,
wherein the head supporting member is associated with the recess for the head, the beak encasing member is associated with the recess for the beak, and the neck supporting member is associated with the recess for the neck.

7. The apparatus according to claim 1,
wherein the light channel runs through at least the head supporting member to a measurement area.

8. The apparatus according to claim 6,
wherein the head supporting member comprises a head receiving aperture and the beak encasing member comprises a beak receiving aperture which are parts of the relief mask.

9. The apparatus according to claim 3,
wherein the light channel is directed to approximately a centered region of an upper bulge of the recess for the beak.

10. The apparatus according to claim 1,
wherein the apparatus comprises a first scavenging air inlet, wherein the scavenging air inlet preferably runs through the light trapping and the head supporting member and opens into the light channel for cleaning said light channel.

11. The apparatus according to claim 6,
wherein a second light trapping is arranged at the beak encasing member and the neck supporting member, wherein preferably a second scavenging air inlet runs through the second light trapping, said second scavenging air inlet opening into the light channel.

12. The apparatus according to claim 1,
wherein a focusing assembly in the form of an objective or a converging lens is arranged within the light channel.

13. The apparatus according to claim 12,
wherein the light channel and/or the sensor access comprise an access to the focusing assembly in order to allow for adjustment of the focusing assembly.

14. The apparatus according to claim 1,
wherein the at least one movable supporting arm is formed as at least one movable locking lever, as a pivotably mounted bow-shaped supporting arm adapted to the body part, and/or is club-shaped.

15. The apparatus according to claim 1,
wherein the movement of the supporting arm is released and reset in a controlled manner, wherein the at least one movable supporting arm is preferably formed for linear displacement or provided pivotally.

16. The apparatus according to claim 1,
wherein the at least one supporting arm is arranged in pairs.

17. The apparatus according to claim 1,
said apparatus further comprising at least one loudspeaker, wherein said loudspeaker preferably communicates with the at least one supporting arm.

18. The apparatus according to claim 6,
wherein the beak encasing member comprises at least two recesses for nostrils.

19. The apparatus according to claim 1, further comprising:
a unit for recording characteristic vibrational spectra, with a light source for producing the stimulation light, a sensor for collecting the back-scattered light, and an analysis unit.

20. The apparatus according to claim 19,
wherein the analysis unit is configured for determining the sex of the living bird using characteristic vibrational spectra in the back-scattered light.

21. The apparatus according to claim 19,
wherein the analysis unit is a Raman spectroscopy unit.

22. A device for determining the sex of living birds using characteristic vibrational spectra, said device comprising:
a rondel or an endless belt; and
at least two apparatuses according to claim 20.

23. (canceled)

24. (canceled)

25. The device according to claim 22,
wherein the device comprises a predetermined first halt position for receiving the birds to be locked and for recording the measured data, and a predetermined second halt position for separating the already sexed birds by means of the separation unit.

26. A method for recording characteristic vibrational spectra of a living bird, wherein the method comprises the following steps:
locking in position a body part of the living bird;
irradiating stimulation light onto the locked body part using a light channel;
guiding back the light back-scattered by the body part locked in position using the light channel;
analyzing the characteristic vibrational spectra of the back-scattered light.

27. (canceled)

28. The method according to claim 26,
wherein the analysis comprises the comparison of a vibrational spectrum of the back-scattered light with at least one reference spectrum of a male and/or a female bird for determining the sex of the bird.

29. The method according to claim 26,
wherein the analysis is carried out by means of Raman spectroscopy.

30. The method according to claim 26,
wherein chemometric methods are used for carrying out the analysis.
